(19) United States
(12) Patent Application Publication
(10) Pub. No.: US 2023/0214496 A1
(43) Pub. Date: Jul. 6, 2023

(54) KNOWLEDGE GENERATION APPARATUS, CONTROL METHOD, AND STORAGE DEVICE

(71) Applicants: NEC Corporation, Tokyo (JP); B. G. Negev Technologies and Applications Ltd., at Ben-Gurion University, Beer-Sheva (IL)

(72) Inventors: Masaki INOKUCHI, Tokyo (JP); Tomohiko YAGYU, Tokyo (JP); Yuval ELOVICI, Arugot (IL); Asaf SHABTAI, Hulda (IL); Ron BITTON, Yehud (IL); Noam MOSCOVICH, Rishon LeZion (IL)

(73) Assignees: NEC Corporation, Tokyo (JP); B. G. Negev Technologies and Applications Ltd., at Ben-Gurion University, Beer-Sheva (IL)

(21) Appl. No.: 17/927,640

(22) PCT Filed: May 29, 2020
(86) PCT No.: PCT/JP2020/021308

§ 371 Date: Nov. 23, 2022

(51) Int. Cl. G06F 21/57; G06F 21/55; G06N 5/022

(52) U.S. Cl. CPC G06F 21/577; G06F 21/552; G06N 5/022

(57) ABSTRACT

The knowledge generation apparatus (2000) obtains a plural pieces of attack result information (100), which includes a configuration of an attack performed on the computer environment, a configuration of the computer environment attacked, and a result of the attack. By comparing the obtained attack result information (100), the knowledge generation apparatus (2000) detects environment conditions, which is regarding the configuration of the computer environment that are necessary for the success of the attack. The knowledge generation apparatus (2000) performs selection on the detected environment conditions based on a selection rule (200), and generates the knowledge information (300) that includes the selected environment conditions. The selection rule represents a rule for determining whether to include the environment condition in the knowledge information (300), with respect to a feature of a set of attacks that are affected by the environment condition.

### TECHNICAL FIELD

The present disclosure generally relates to computer security, in particular, attacks on computer systems.

### BACKGROUND ART

Risk assessment is required to improve the security of computer systems. Therefore, various systems for facilitating risk assessment have been developed. PTL 1 discloses a technique to perform a requirements analysis of a computer system from the viewpoint of the security. The system disclosed by PTL 1 provides an attacker model that indicates elements (e.g. computer resources) necessary for achieving a goal of an attacker and dependencies among the elements. PTL 2 discloses a technique to evaluate the security of a target device by performing various attacks on the device using an evaluation device.

### CITATION LIST

### Patent Literature

PTL 1: Japanese Patent Application Publication No. 2008-250680
PTL 2: Japanese Patent Application Publication No. 2015-114833

### SUMMARY OF INVENTION

### Technical Problem

The output of the systems disclosed by the above-mentioned patent literatures could include some unuseful information from the viewpoint of the risk assessment. In terms of PLT 1, the system excludes some of the elements from the attacker model based on the redundancy and contradiction among the elements. However, other aspects than redundancy and contradiction among the elements are not taken into account. In terms of PTL 2, there is no discussion of the necessity to exclude unuseful information from its output.

One of the objectives of the present disclosure is to provide a technique that enables to provide useful information for risk assessment.

### Solution to Problem

The present disclosure provides a knowledge generation apparatus comprising at least one processor and a memory storing instructions. The at least one processor is configured to execute the instructions to: obtain plural pieces of attack result information each of which includes a configuration of an attack performed on a computer environment, a configuration of the computer environment, and a result of the attack; detect, through a comparison among the plural pieces of the attack result information, one or more environment conditions each of which is a condition regarding the configuration of the computer environment that is necessary for success of the attack; and generate knowledge information that includes some of the detected environment conditions, the part of the detected environment being selected based on a selection rule, the selection rule being a rule for determining whether to select the environment condition based on a feature of a set of attacks affected by the environment condition.

The present disclosure further provides a knowledge generation apparatus comprising at least one processor and a memory storing instructions. The at least one processor is configured to execute the instructions to: obtain plural pieces of attack result information each of which includes a configuration of an attack performed on a computer environment, a configuration of the computer environment, and a result of the attack; detect, through a comparison among the plural pieces of the attack result information, one or more environment conditions each of which is a condition regarding the configuration of the computer environment that is necessary for success of the attack; converting the result of the attack affected by the detected environment condition into a generalized problem, based on a predefined association between the result of the attack and the generalized problem; for each generalized problem, generating knowledge information that includes the generalized problem and the selected environment condition that affects the attack whose result is converted into that generalized problem.

The present disclosure further provides a control method that is performed by a computer. The control method comprises: obtaining plural pieces of attack result information each of which includes a configuration of an attack performed on a computer environment, a configuration of the computer environment, and a result of the attack; detecting, through a comparison among the plural pieces of the attack result information, one or more environment conditions each of which is a condition regarding the configuration of the computer environment that is necessary for success of the attack; and generating knowledge information that includes some of the detected environment conditions, the part of the detected environment being selected based on a selection rule, the selection rule being a rule for determining whether to select the environment condition based on a feature of a set of attacks affected by the environment condition.

The present disclosure further provides a control method that is performed by a computer. The control method comprises: obtaining plural pieces of attack result information each of which includes a configuration of an attack performed on a computer environment, a configuration of the computer environment, and a result of the attack; detecting, through a comparison among the plural pieces of the attack result information, one or more environment conditions each of which is a condition regarding the configuration of the computer environment that is necessary for success of the attack; converting the result of the attack affected by the detected environment condition into a generalized problem, based on a predefined association between the result of the attack and the generalized problem; and for each generalized problem, generating knowledge information that includes the generalized problem and the selected environment condition that affects the attack whose result is converted into the generalized problem.

The present disclosure further provides a non-transitory computer readable storage medium storing a program. The program causes a computer to perform: obtaining plural pieces of attack result information each of which includes a configuration of an attack performed on a computer environment, a configuration of the computer environment, and a result of the attack; detecting, through a comparison among the plural pieces of the attack result information, one or more environment conditions each of which is a condition regarding the configuration of the computer environment that is necessary for success of the attack; generating knowledge information that includes some of the detected environment conditions, the part of the detected environment being selected based on a selection rule, the selection rule being a rule for determining whether to select the environment condition based on a feature of a set of attacks affected by the environment condition.

The present disclosure further provides a non-transitory computer readable storage medium storing a program. The program causes a computer to perform: obtaining plural pieces of attack result information each of which includes a configuration of an attack performed on a computer environment, a configuration of the computer environment, and a result of the attack; detecting, through a comparison among the plural pieces of the attack result information, one or more environment conditions each of which is a condition regarding the configuration of the computer environment that is necessary for success of the attack; converting the result of the attack affected by the detected environment condition into a generalized problem, based on a predefined association between the result of the attack and the generalized problem; and for each generalized problem, generating knowledge information that includes the generalized problem and the selected environment condition that affects the attack whose result is converted into the generalized problem.

### Advantageous Effects of Invention

According to the present disclosure, it is possible to provide a technique that enable to provide useful information for risk assessment.

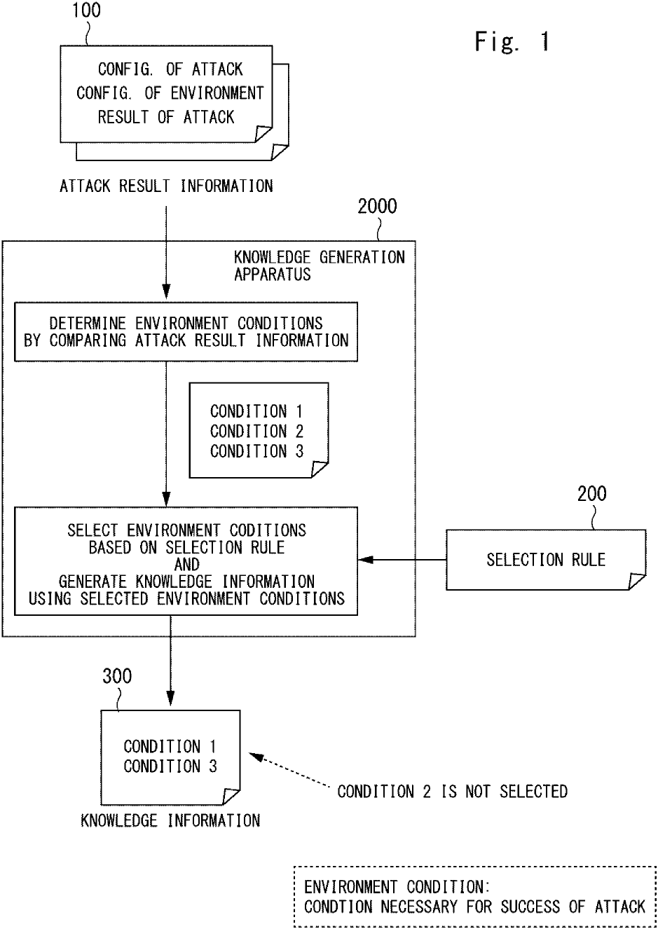

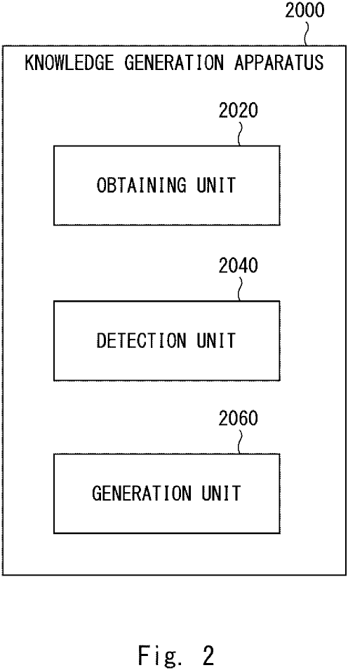

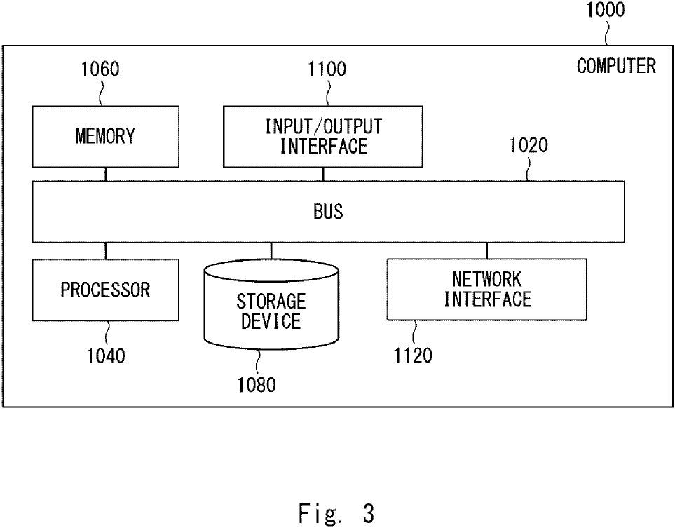

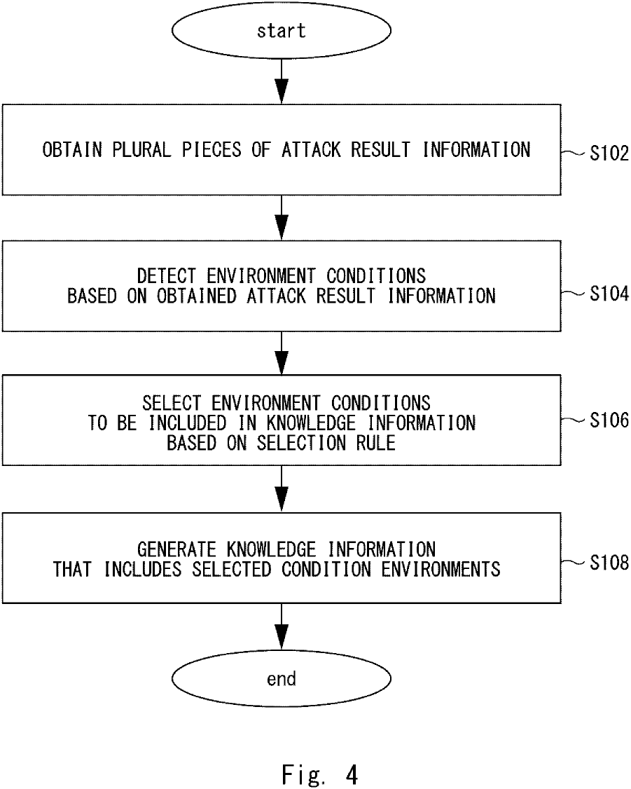

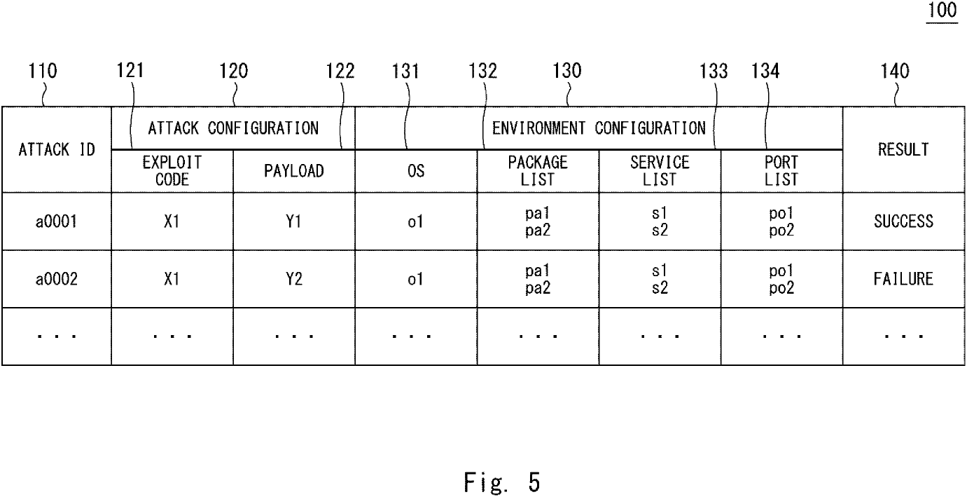

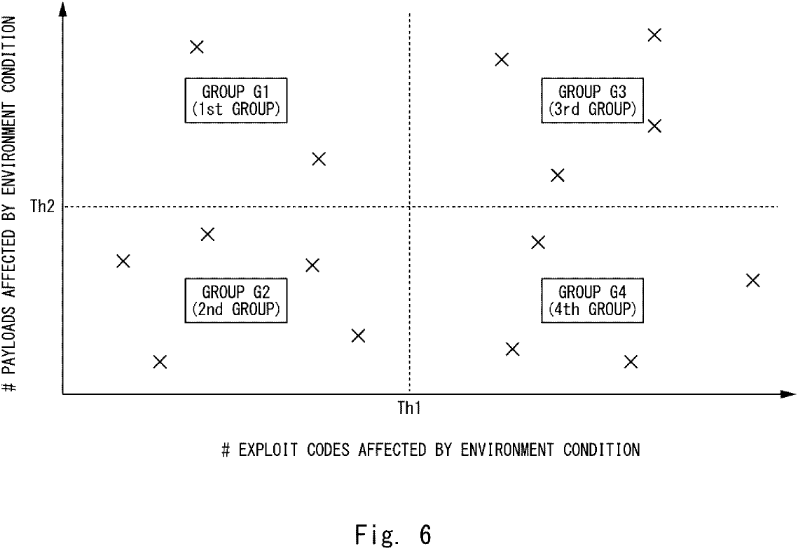

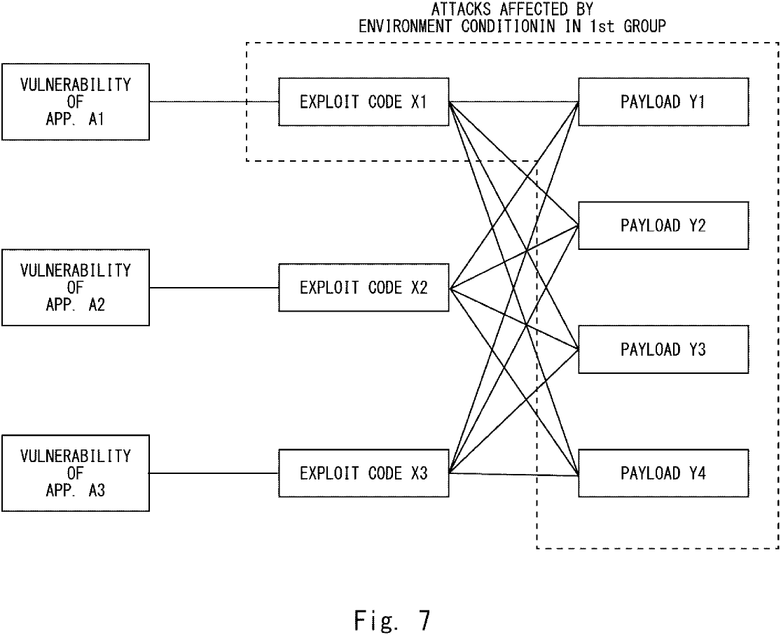

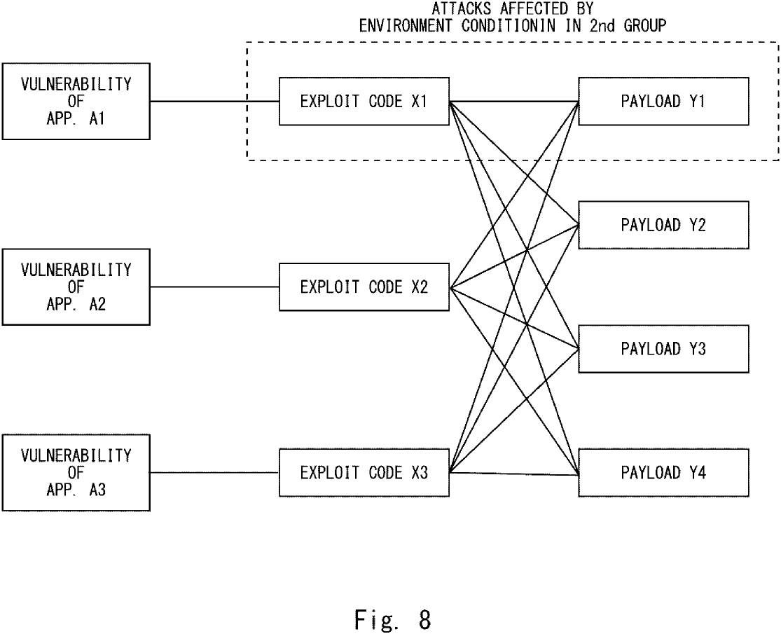

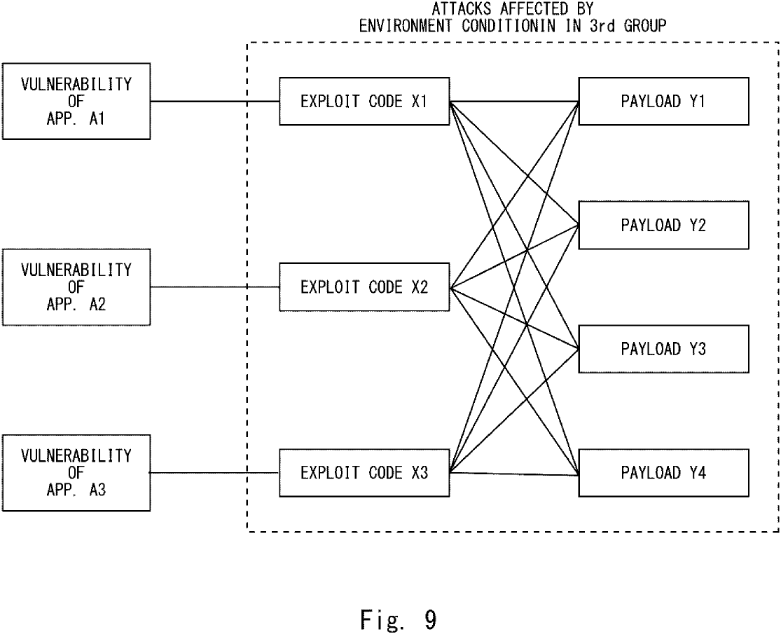

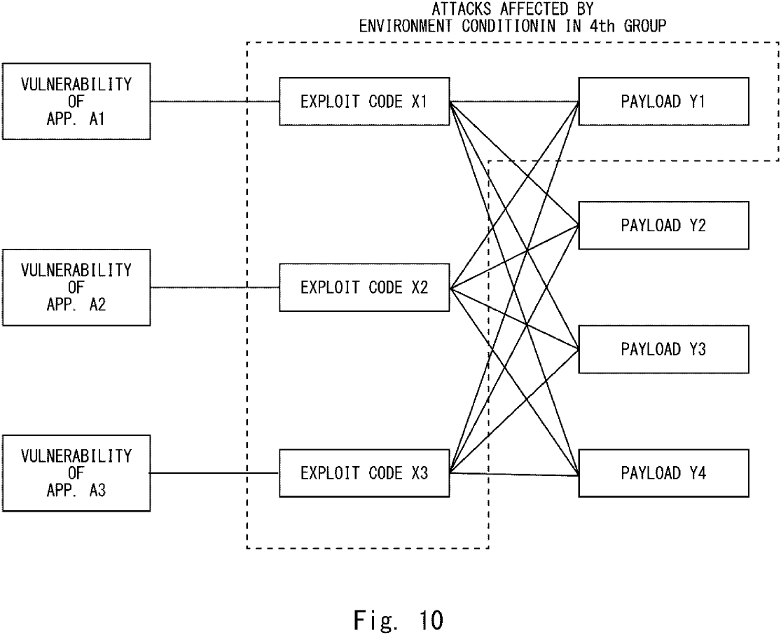

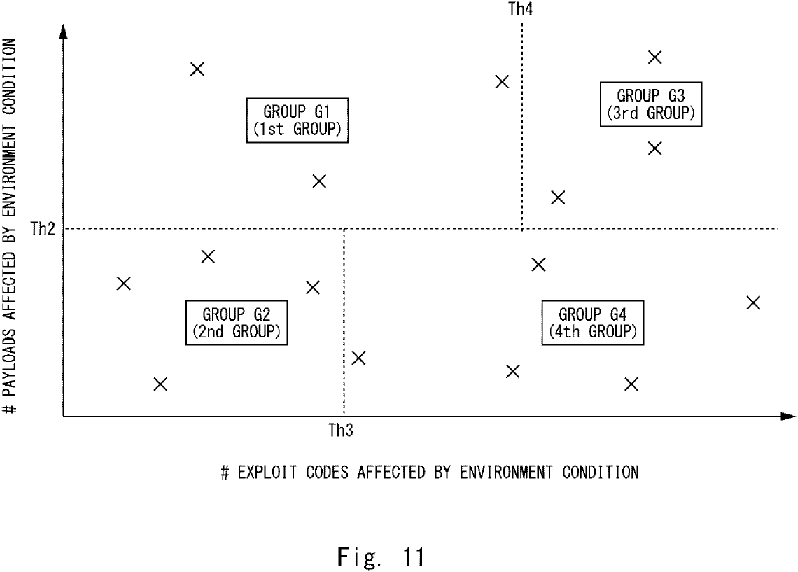

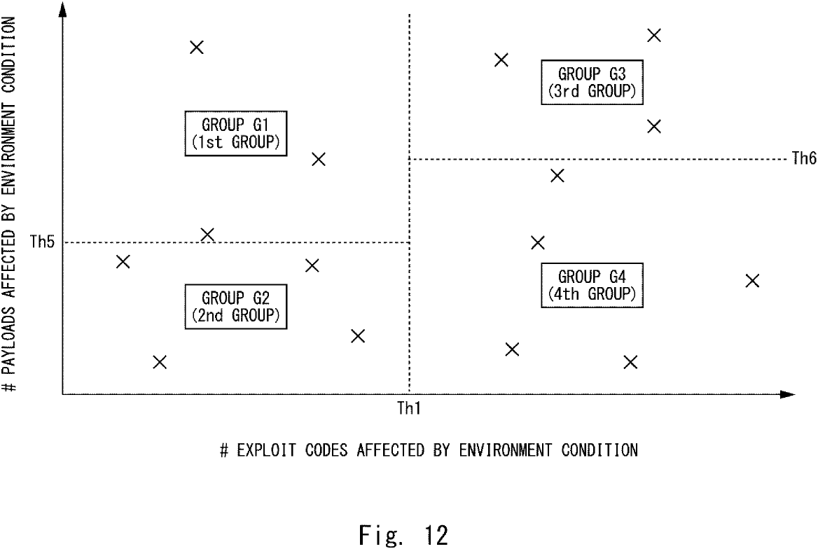

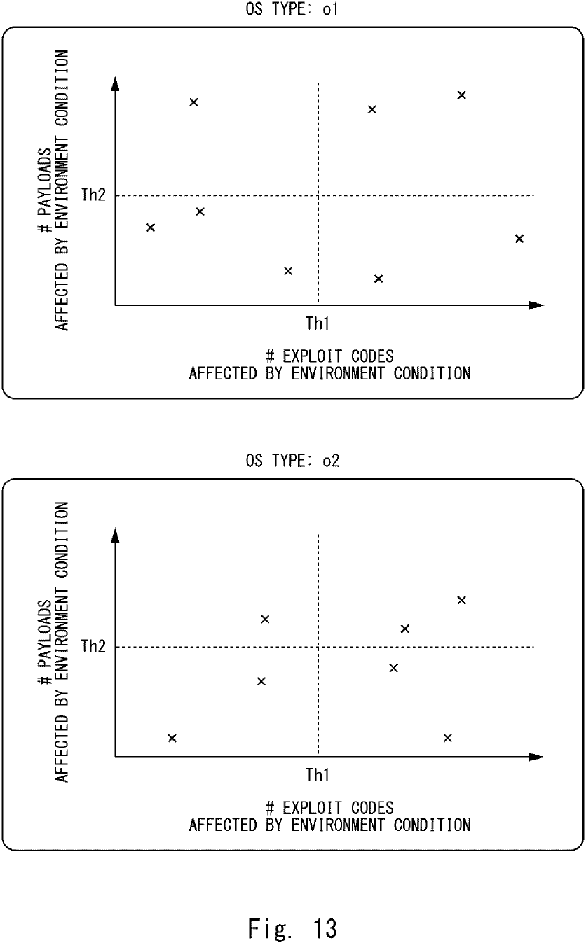

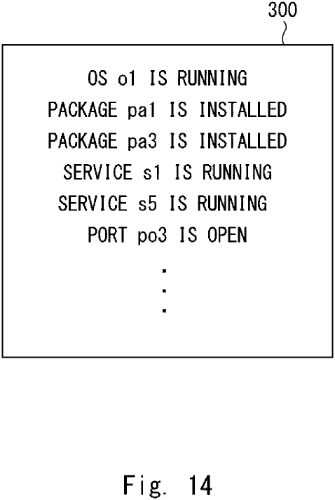

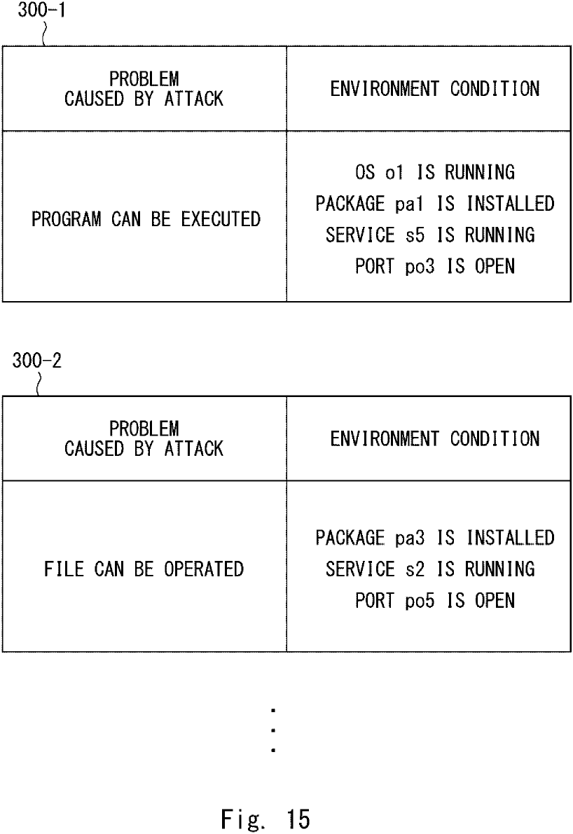

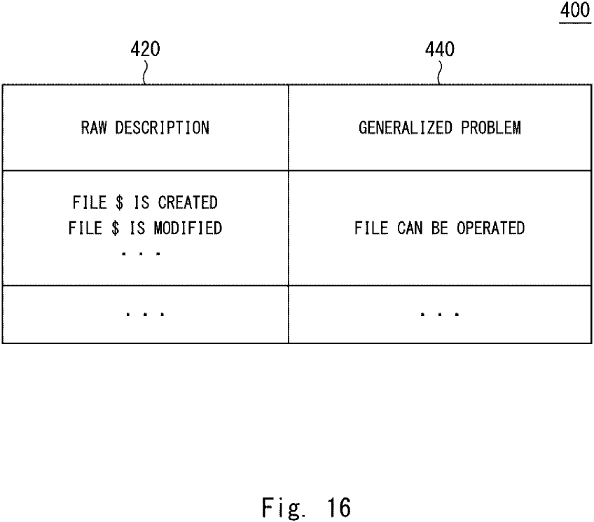

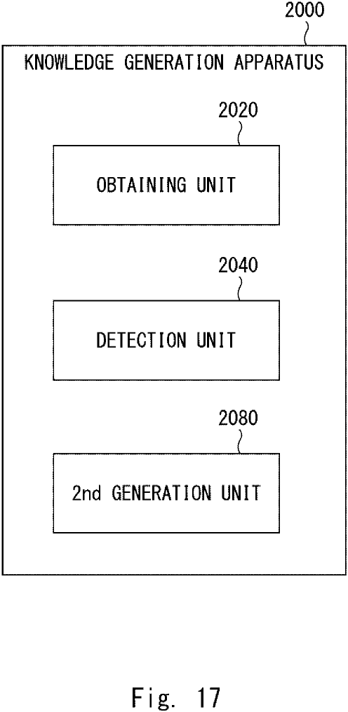

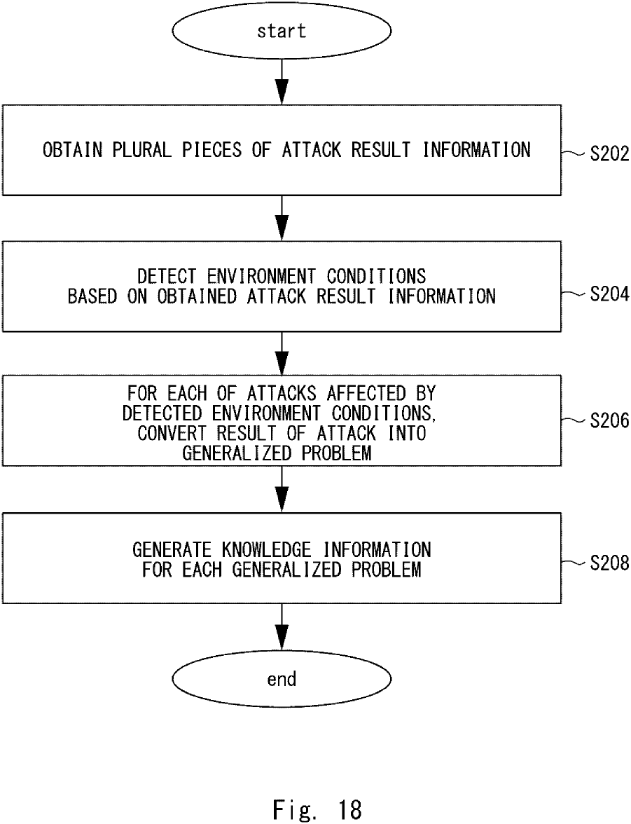

### BRIEF DESCRIPTION OF DRAWINGS

[FIG. 1]FIG. 1 illustrates a concept of a knowledge generation apparatus according to the 1st example embodiment.

[FIG. 2]FIG. 2 is a block diagram illustrating an example of the functional configuration of the knowledge generation apparatus of the 1st example embodiment.

[FIG. 3]FIG. 3 is a block diagram illustrating an example of the hardware configuration of a computer realizing the knowledge generation apparatus.

[FIG. 4]FIG. 4 is a flowchart illustrating an example flow of processes that the knowledge generation apparatus of the 1st example embodiment performs.

[FIG. 5]FIG. 5 illustrates an example structure of the attack result information.

[FIG. 6]FIG. 6 illustrates the groups of the environment condition.

[FIG. 7]FIG. 7 illustrates examples of the attacks affected by the environment condition belonging to the 1st group.

[FIG. 8]FIG. 8 illustrates examples of the attacks affected by the environment condition belonging to the 2nd group.

[FIG. 9]FIG. 9 illustrates examples of the attacks affected by the environment condition belonging to the 3rd group.

[FIG. 10]FIG. 10 illustrates examples of the attacks affected by the environment condition belonging to the 4th group.

[FIG. 11]FIG. 11 is a first diagram illustrating another example of boundaries for dividing the environment conditions into groups.

[FIG. 12]FIG. 12 is a second diagram illustrating another example of boundaries for dividing the environment conditions into groups.

[FIG. 13]FIG. 13 illustrates classification of the computer environments for each OS type.

[FIG. 14]FIG. 14 is a first diagram illustrating an example structure of the knowledge information.

[FIG. 15]FIG. 15 is a second diagram illustrating an example structure of the knowledge information.

[FIG. 16]FIG. 16 illustrates an example structure of the conversion rule.

[FIG. 17]FIG. 17 is a block diagram illustrating an example of a functional configuration of the knowledge generation apparatus of the 2nd example embodiment.

[FIG. 18]FIG. 18 is a flow chart illustrating a flow of processes that the knowledge generation apparatus of the 2nd example embodiment performs

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary.

### First Example Embodiment

FIG. 1 illustrates a concept of a knowledge generation apparatus 2000 according to the first example embodiment. Please note that, FIG. 1 does not limit operations of the knowledge generation apparatus 2000, but merely show an example of possible operations of the knowledge generation apparatus 2000.

The knowledge generation apparatus 2000 provides information about conditions regarding a computer environment that are necessary to successfully attack the computer environment, such as “portpo1 is open”, “service s1 is running”, and so on. The term “computer environment” may indicate a single machine or a computer system formed with plural machines. Hereinafter, the above-mentioned information provided by the knowledge generation apparatus 2000 is described as “knowledge information”.

The knowledge generation apparatus 2000 generates the knowledge information 300 based on a plurality of results of attacks performed on a computer environment. For this reason, the knowledge generation apparatus 2000 obtains plural pieces of attack result information 100. The attack result information 100 includes a configuration of an attack performed on the computer environment, a configuration of the computer environment attacked, and a result of the attack. The plural pieces of attack result information 100 are different from each other in the configuration of the attack, the configuration of the computer environment, or both.

By comparing plural pieces of the obtained attack result information 100, the knowledge generation apparatus 2000 detects conditions regarding the configuration of the computer environment that are necessary for the success of the attack. Hereinafter, a condition regarding the configuration of the computer environment detected to be necessary for the success of the attack is described as “environment condition”. As a simple example, suppose that the attack result information i1 shows that an attack a1 succeeds when a service s1 is running on the computer environment, whereas the attack result information i2 shows that the attack a1 fails when the service s1 is not running on the computer environment. In this case, by comparing i1 and i2, “service s1 is running” may be detected as the environment condition.

However, from the viewpoint of risk assessment or the like, some of the environment conditions detected as described above could be less useful than other ones due to some reasons. For example, if satisfying a certain environment condition c1 is inevitable for a normal operation of the computer environment, it is difficult to disable the environment condition c1. Thus, the knowledge that “an attack fails if the environment condition c1 is not satisfied” may be considered unuseful. Note that, in this specification, “to disable the environment condition” means “to configure the computer environment so that the environment condition is not satisfied”. Similarly, “to enable the environment condition” means “to configure the computer environment so that the environment condition is satisfied”.

Based on the above-mentioned insight, the knowledge generation apparatus 2000 narrows down the environment conditions to be provided to users. Specifically, the knowledge generation apparatus 2000 performs selection of the detected environment conditions based on a selection rule 200, and generates the knowledge information 300 that includes the selected environment conditions. In other words, some of the environment conditions detected by the comparison among the plural pieces of the attack result information 100 could be excluded from the knowledge information 300.

The selection rule 200 may represent a rule for determining whether to include the environment condition in the knowledge information 300, based on a feature of a set of attacks that are affected (i.e. whose result are affected) by the environment condition. Thus, when determining whether to select a certain environment condition, the knowledge generation apparatus 2000 computes the feature of attacks affected by that environment condition. Then, the knowledge generation apparatus 2000 determines whether to select that environment condition by comparing the computed feature with the selection rule 200.

### Example of Advantageous Effect

As described above, the knowledge generation apparatus 2000 of the 1st example embodiment determines whether to include the environment condition, which regards the configuration of the computer environment to be satisfied for the success of the attack, in the knowledge information based on the feature of the set of the attacks affected by the environment condition. In other words, only the environment condition that is determined to be included in the knowledge information based on the feature of the set of the attacks affected by the environment condition is provided to users. Thus, the knowledge generation apparatus 2000 of the 1st example embodiment enables knowledge that is useful from the viewpoint of risk assessment to be provided. In other words, it is able to avoid providing users with knowledge that is not useful from the viewpoint of risk assessment.

Hereinafter, more detailed explanation of the knowledge generation apparatus 2000 will be described.

### Example of Functional Configuration

FIG. 2 illustrates an example of the functional configuration of the knowledge generation apparatus 2000 of the 1st example embodiment. In FIG. 2, the knowledge generation apparatus 2000 includes the obtaining unit 2020, detection unit 2040, and generation unit 2060. The obtaining unit 2020 obtains plural pieces of the attack result information 100. The detection unit 2040 detects one or more environment conditions through the comparison among the plural pieces of the attack result information 100. The generation unit 2060 selects one or more environment conditions from the detected environment conditions based on the selection rule 200, and generate the knowledge information 300 that indicates the selected environment conditions.

### Example of Hardware Configuration

The knowledge generation apparatus 2000 may be realized by one or more computers. Each of the one or more computers may be a special-purpose computer manufactured for implementing the knowledge generation apparatus 2000, or may be a general-purpose computer like a personal computer (PC), a server machine, or a mobile device. The knowledge generation apparatus 2000 may be realized by installing an application in the computer. The application is implemented with a program that causes the computer to function as the knowledge generation apparatus 2000. In other words, the program is an implementation of the functional units of the knowledge generation apparatus 2000.

FIG. 3 is a block diagram illustrating an example of the hardware configuration of a computer 1000 realizing the knowledge generation apparatus 2000. In FIG. 3, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the knowledge generation apparatus 2000. In addition, the storage device 1080 may store the attack result information 100 and the selection rule 200. However, the knowledge generation apparatus 2000 may obtain the attack result information 100, the selection rule 200, or both from one or more storage devices that are installed outside the computer 1000.

The hardware configuration of the computer 1000 is not limited to the configuration shown in FIG. 3. For example, as mentioned-above, the knowledge generation apparatus 2000 may be realized by plural computers. In this case, those computers may be connected with each other through the network.

### Flow of Process

FIG. 4 is a flowchart illustrating an example flow of processes that the knowledge generation apparatus 2000 of the 1st example embodiment performs. The obtaining unit 2020 obtains plural pieces of the attack result information 100 (S102). The detection unit 2040 detects environment conditions based on the obtained attack result information 100 (S104). The generation unit 2060 selects environment conditions to be included in the knowledge information 300 based on the selection rule 200 (S106). The generation unit 2060 generates the knowledge information 300 that includes the selected condition environments (S108).

### Attack Result Information

As mentioned above, the attack result information 100 may include the configuration of the attack performed on the computer environment, the configuration of the computer environment attacked, and the result of the attack. The configuration of the attack may include one or more attributes, such as an exploit code and a payload. The exploit code includes a program aimed at exploiting a weakness (i.e. vulnerability) of the computer environment. The payload includes a program aimed at achieving a goal of the attack after the vulnerability of the computer environment is successfully exploited. For example, the exploit code may be a program to exploit a buffer overflow vulnerability of the computer environment, and the payload may be a malware that is executed on the computer environment after the buffer on the computer environment is overflowed by the exploit code.

The configuration of the computer environment may include one or more attributes, such as an operating system running in the computer environment, packages installed in the computer environment, services running in the computer environment, open ports, existence of user accounts, execution right of processes, access right to files, security measures (e.g. antivirus software, an intrusion prevention system, an intrusion detection system, and a whitelist of applications), and so on. Note that the package is a management unit of components (e.g. execution files, configuration files, and libraries) necessary for operating an application.

The result of an attack may indicate information by which it is possible to determine whether the attack is successful or not. Note that, the result of attack does not necessarily show success or failure of the attack directly. For example, if the attack is successful, the result of attack may show one or more problems caused by the attack. Suppose that, the result of the attack shows that “an unknown program is executed with the root privilege”. From this result, it is possible to recognize that the attack on the computer environment is successful.

### Example Structure of Attack Result Information

There is no limitation on the concrete structure of the attack result information 100. FIG. 5 illustrates an example structure of the attack result information 100. In FIG. 5, the attack result information 100 is structured in a table format. The attack result information 100 includes columns of an attack identifier (ID) 110, an attack configuration 120, an environment configuration 130, and a result 140. The attack ID represents an identifier that is assigned to each attack performed on the computer environment.

The attack configuration 120 represents the configuration of the attack. Specifically, in this example, the attack configuration 120 includes columns of an exploit code 121 and a payload 122. The exploit code 121 and the payload 122 respectively represent the exploit code and the payload that is used to attack the computer environment.

The environment configuration 130 represents the configuration of the computer environment. Specifically, in this example, the environment configuration 130 includes columns of an OS 131, a package list 132, a service list 133, and a port list 134. The OS 131 represents an OS running in the computer environment. In other words, the OS 131 represents an OS running on a machine included in the computer environment. The package list 132 represents a list of packages installed in the computer environment. The service list 133 represents a list of services running in the computer environment. The port list 134 represent a list of ports (e.g. TCP or UDP ports) that are open toward the outside of the computer environment.

Please note that the above-mentioned attributes of the computer environment are merely examples of the configuration of the computer environment that can be modified. The configuration of the computer environment may include any other attributes that can possibly affect the result of the attack. Furthermore, one or more of the above-mentioned attributes may not be included in the configuration of the computer environment.

### Generation of Attack Result Information

The attack result information 100 is generated by attacking the computer environment under various configurations of the attack and the computer environment. As a simple example, suppose that there are N possible configurations of the attack, and M possible configurations of the computer environment. In this case, theoretically, there could be NxM possible attacks. Thus, each of these NxM possible attacks may be performed on the computer environment, thereby generating NxM pieces of the attack result information 100. However, it is not necessary to perform all of the possible attacks to generate the attack result information 100.

Note that, the computer environment to be attacked may be a representation of an arbitrary computer environment or it may be a representation of an existing computer environment. In the latter case, for example, by attacking the computer environment with various attack configurations, it is possible to detect attacks that are successful on the computer environment with the current real configuration. After that, the attacks that were successful are performed again on the computer environment while variously changing the configuration of the computer environment. As a result, it is possible to obtain the attack result information indicating a successful attack and the attack result information indicating an unsuccessful attack. Then, by comparing these pieces of the attack result information, the knowledge generation apparatus 2000 can detect the environment conditions that are required for making it possible for the existing environment condition to be vulnerable to the attacks. This detected environment condition can be considered as knowledge for avoiding such attacks.

In order to perform the attack with a specific configuration of the computer environment, it is necessary to configure the computer environment as intended. This configuration may be realized by an arbitrary way, either manually or automatically. Note that, arbitrary well-known technique can be applied as a way of configuring the configuration of the computer environment as intended. For example, the computer environment is realized by one or more virtual machines. Because the configuration of virtual machines can be modified easier than that of physical machines, it is possible to easily configure the computer environment as intended.

Note that, the generation of the attack result information may be performed by the knowledge generation apparatus 2000 or by a machine other than the knowledge generation apparatus 2000.

### Obtaining Attack Result Information: S102

The obtaining unit 2020 obtains the plural pieces of the attack result information 100 (S102). There may be variety of ways to obtain the attack result information 100. For example, the attack result information 100 to be obtained by the obtaining unit 2020 is stored in advance in a storage device to which the obtaining unit 2020 have access. In this case, the obtaining unit 2020 read the plural pieces of the attack result information 100 out of the storage device. In another example, the obtaining unit 2020 may receive the attack result information 100 sent from a system that generates the attack result information 100. In another example, the knowledge generation apparatus 2000 itself may generate the attack result information 100.

### Determination of Environment Conditions: S104

The detection unit 2040 detects environment conditions that are necessary for success of the attack on the computer environment (S106). This determination is performed by comparing the plural pieces of the attack result information 100 obtained. For example, the detection unit 2040 classifies the plural pieces of the attack result information 100 into groups based on the configurations of attack. Specifically, plural pieces of the attack result information 100 whose configurations of attack are the same as each other are classified into the same group. Then, for each group, the detection unit 2040 compares the plural pieces of the attack result information 100 in that group with each other. By doing so, the detection unit 2040 can detect one or more conditions regarding the configuration of the computer environment that are necessary to achieve the attack corresponding to the group. The conditions regarding the configuration of the computer environment detected through the above comparison are handled as a computer environment. Note that, a concrete method of comparing the plural pieces of the obtained attack result information 100 to detect the environment condition is not limited to the above-mentioned way.

### Selection of Environment Conditions: S106

The generation unit 2060 selects the environment conditions to be included in the knowledge information 300 from the environment conditions detected in Step S104 based on the selection rule 200 (S106). Whether to include the environment condition in the knowledge information 300 is determined based on a feature of a set of attacks affected by that environment condition. Note that, “the attack is affected by the environment condition” means that “the attack is successful if the environment condition is enabled, whereas the attack is not successful if the environment condition is disabled.”

For example, the selection rule 200 may include a condition (inclusion condition, hereinafter) for including an environment condition in the knowledge information 300, the inclusion condition being one regarding the feature of the set of attacks affected by that environment condition. For each environment condition detected in Step S104, the generation unit 2060 computes the feature of the set of the attacks affected by that environment condition based on the attack result information 100, and determines whether the computed feature satisfies the inclusion condition shown by the selection rule 200. If the computed feature satisfies the inclusion condition, the generation unit 2060 determines to include that environment condition in the knowledge information 300. On the other hand, if the computed feature does not satisfy the inclusion condition, the generation unit 2060 determines not to include that environment condition in the knowledge information 300.

Suppose that there are four attacks a1 to a4, whose results are successful if the environment condition e1 is satisfied. In this case, whether to include the environment condition e1 in the knowledge information 300 depends on the feature of the set of the attacks a1 to a4. If it is determined that the feature of this set satisfies the inclusion condition in the selection rule 200, the generation unit 2060 includes the environment condition e1 in the knowledge information 300. On the other hand, if it is determined that the feature of the set of attacks a1 to a4 does not satisfy the inclusion condition in the selection rule 200, the generation unit 2060 does not include the environment condition e1 in the knowledge information 300.

Note that, the selection rule 200 may include a plurality of inclusion conditions. In this case, for example, the generation unit 2060 may determine to include the environment condition in the knowledge information 300 if the computed feature satisfies any one of the inclusion conditions in the selection rule 200.

Instead of an inclusion condition, the selection rule 200 may include a condition (exclusion condition, hereinafter) for not including the environment condition in the knowledge information 300, the exclusion condition being one regarding the feature of the set of attacks affected by the environment condition. In this case, for each environment condition, the generation unit 2060 computes the feature of the set of the attacks affected by that environment condition, and determines whether the computed feature satisfies the exclusion condition in the selection rule 200. If the computed feature satisfies the exclusion condition, the generation unit 2060 determines not to include that environment condition in the knowledge information 300. On the other hand, if the computed feature does not satisfy the exclusion condition, the generation unit 2060 determines to include that environment condition in the knowledge information 300.

### Examples of Selection Rule

Hereinafter, examples of selection rules 200 are described. For example, each environment condition is classified into one of plural groups of environment conditions based on the feature of the set of attacks affected by the environment condition. In this case, the inclusion condition may represent one or more of the groups whose environment conditions are to be included in the knowledge information 300.

In order to select the environment condition to be included in the knowledge information 300, for each environment condition, the generation unit 2060 determines to which group the environment condition belongs and determines whether the group which is determined to be the one the environment condition belongs to is included in the groups indicated by the inclusion condition. If the group which is determined to be the one the environment condition belongs to is included in the groups indicated by the inclusion condition, the generation unit 2060 determines to include the environment condition in the knowledge information 300. On the other hand, if the group which is determined to be the one the environment condition belongs to is not included in the groups indicated by the inclusion condition, the generation unit 2060 determines not to include the environment condition in the knowledge information 300.

Here, example ways of classifying the environment condition will be described. Suppose that the configuration of attack includes an exploit code and a payload. In a set of attacks, there would be some exploit codes affected by the environment condition: the results of the attacks are successful when the environment condition is enabled but are unsuccessful when the environment condition is disabled. Similarly, there would be some payloads affected by the environment condition: their results are successful when enabling the environment condition but are unsuccessful when disabling the environment condition.

Therefore, the number of exploit codes and payloads that are affected by the environment condition can be handled as the feature of the set of attacks. Note that, if payloads take parameters (i.e. each payload is formed with a combination of a code and parameters), the payloads with the same code but different parameters may be counted as being the same payloads or different payloads. Based on the number of exploit codes and payloads that are affected by the environment condition, the environment condition may fall into one of four groups: a first group for the environment conditions that affect a small number of exploit codes and a large number of payloads; a second group for the environment conditions that affect a small number of exploit codes and a small number of payloads; a third group for the environment conditions that affect a large number of exploit codes and a large number of payloads; and a fourth group for the environment conditions that affect a large number of exploit codes and a small number of payloads.

FIG. 6 illustrates the groups of the environment condition. Groups G1 to G4 correspond to the 1st to 4th groups, respectively. The horizontal axis represents the number of the exploit codes affected by the environment condition. The vertical axis represents the number of the payloads affected by the environment condition. Each plot corresponds to one of the environment conditions detected by the detection unit 2040. Specifically, the plot corresponding to a certain environment condition represents a pair of the number of the exploit codes and the number of the payloads affected by that environment condition.

Threshold th1 represents a boundary between the number of the exploit codes considered to be large and that considered to be small. Specifically, the number of the exploit codes equal to or greater than th1 is handled as being large, whereas that less than th1 is handled as being small. Similarly, threshold th2 represents a boundary between the number of the payloads considered to be large and that considered to be small. Specifically, the number of the payloads equal to or greater than th2 is handled as being large, whereas that being less than th2 is handled as being small.

Suppose that the selection rule 200 shows an inclusion condition that “the environment condition is classified into the group G2 (in other words, the number of the exploit codes is smaller than th1, and the number of the payloads is smaller than th2)”. In this case, the generation unit 2060 computes, as the feature of the set of attacks affected by the environment condition, the number of the exploit codes and the payloads affected by that environment condition. Then, the generation unit 2060 determines whether the environment condition is classified into the group G2, by comparing the computed number of the exploit codes with the threshold th1 and comparing the computed number of the payloads with the threshold th2. If it is determined that the environment condition is classified into the group G2, the generation unit 2060 determines to include the environment condition in the knowledge information 300. On the other hand, if it is determined that the environment condition is not classified into the group G2, the generation unit 2060 determines not to include the environment condition in the knowledge information 300.

Note that, the number of exploit codes may be represented as a value relative to the number of payloads (e.g. the actual number of exploit codes divided by the actual number of the payloads), or vice versa. When the number of exploit codes is represented as a value relative to the number of payloads, the threshold regarding the number of the exploit codes, e.g. th1, is also represented as a ratio of the number of exploit codes to the number of payloads. Similarly, when the number of payloads is represented as a value relative to the number of exploit codes, the threshold regarding the number of the payloads, e.g. th2, is also represented as a ratio of the number of payloads to the number of exploit codes.

Here, the characteristics of the 1st to 4th group will be described. FIG. 7 illustrates examples of the attacks affected by the environment condition belonging to the 1st group. In FIG. 7, attacks on an application are represented by pairs of the exploit code exploiting the vulnerability of the application and one of the payloads. For example, the pair of the exploit code X1 and the payload Y1 describes one of the attacks on the application A1.

Since the 1st group represents that the number of the payloads affected by the environment condition is large whereas the number of the exploit codes affected by the environment condition is small, it is highly possible that the attacks become unsuccessful regardless of their payloads as a result of the environment condition being disabled. For example, FIG. 7 shows that the attacks having the exploit code X1 become unsuccessful regardless of their payloads as a result of the environment condition being disabled. This may mean that this environment condition is useful to avoid the attacks that exploit a vulnerability specific to an application. Thus, this environment condition may be a useful knowledge from the viewpoint of risk assessment with high probability.

FIG. 8 illustrates examples of the attacks affected by the environment condition belonging to the 2nd group. Since the 2nd group represents that both the number of the exploit codes and the number of the payloads affected by the environment condition are small, it is highly possible that the attacks configured by specific pairs of the exploit code and the payload become unsuccessful due to the environment condition being disabled. For example, FIG. 8 shows that the attack configured with the pair of the exploit code X1 and the payload Y1 becomes unsuccessful due to the environment condition being disabled. This may mean that this environment condition is useful to avoid the attacks formed with a specific pair of the exploit code and the payload. Thus, this environment condition may be a useful knowledge from the viewpoint of risk assessment with high probability.

FIG. 9 illustrates examples of the attacks affected by the environment condition belonging to the 3rd group. Since the 3rd group represents that both the number of the exploit codes and the number of payloads affected by the environment condition are large, it is highly possible that the attacks become unsuccessful regardless of their configurations. For example, FIG. 9 shows that all of the attacks become unsuccessful due to the environment condition being disabled. This may mean that it is not preferable to disable this environment condition because it may affect not only the attacks but also normal operations of the computer environment. Thus, this environment condition may be unuseful from the viewpoint of risk assessment with high probability.

FIG. 10 illustrates examples of the attacks affected by the environment condition belonging to the 4th group. Since the 4th group represents that the number of the exploit codes affected by the environment condition is large whereas the number of the payloads affected by the environment condition is small, it is highly possible that the environment condition affects merely specific payloads. For example, FIG. 10 shows that the environment condition affects only the attacks having the payload Y1. Thus, this environment condition may be unuseful from the viewpoint of risk assessment with high probability.

It is preferable to define the selection rule 200 based on the characteristics of each groups mentioned above. For example, the selection rule 200 is defined so that the environment condition classified into the 3rd or 4th groups is selected to be included in the knowledge information 300. However, there is no limitation to the selection rule 200 as long as there is at least one group whose environment condition is determined not to be included in the knowledge information 300. For example, the selection rule 200 may be defined so that the environment condition classified into the 4th group is selected to be included in the knowledge information 300. In another example, the selection rule 200 may be defined so that the environment condition classified into the 2nd, 3rd or 4th groups is selected to be included in the knowledge information 300.

Note that the generation unit 2060 does not necessarily handle both the number of exploit codes and the number of payloads as the feature of attacks. Suppose that the selection rule 200 indicates that “the environment condition classified into the 3rd or 4th group is selected to be included in the knowledge information 300” in the example of FIG. 6. In this case, it is not necessary to take the number of payloads into account to determine whether to include the environment condition in the knowledge information 300. Thus, the generation unit 2060 is not required to handle the number of payloads as the feature of attacks.

Note that boundaries for dividing the environment conditions into four groups mentioned above are not limited to two lines perpendicular to each other. For example, a threshold for separating the 1st and 3rd groups may be different from that for separating the 2nd and 4th groups. Similarly, a threshold for separating the 1st and 2nd groups may be different from that for separating the 3rd and 4th groups. FIGS. 11 and 12 illustrate other examples of boundaries for dividing the environment conditions into groups. In FIG. 11, the threshold th3 separates the 2nd and 4th groups, whereas the threshold th4 separates the 1st and 3rd groups. In FIG. 12, the threshold th5 separates the 1st and 2nd groups, whereas the threshold th6 separates the 3rd and 4th groups.

There are various ways to define boundaries of the groups of environment conditions, e.g. the thresholds th1 and th2 in FIG. 6. For example, the administrator or the like of the knowledge generation apparatus 2000 may define each boundary of the groups manually. In another example, each boundary of the groups is determined through machine learning. Specifically, plural sets of the feature of the attacks affected by the environment condition and the group to which that environment condition belongs are prepared as a training data set. Then, a discriminator, which feeds the feature of the set of the attacks affected by the environment condition to be classified and assigns one of the groups to that environment condition, is trained with the training data set. As a result of the training, it is possible to determine the boundaries of the groups based on the trained parameters of the discriminator.

The attack result information 100 may be further classified. For example, before classifying the environment condition in accordance with the feature of the set of the attacks, the generation unit 2060 may classify the environment condition based on an OS running in the computer environment attacked. In this case, for example, the detection unit 2040 divides the plural pieces of the attack result information 100 into groups based on the OS indicated by the attack result information 100, and detects the environment condition for each group. Then, for each group of the OS, the generation unit 2060 further divides the environment condition into groups based on the feature of the attacks as described above. Note that, this classification may be performed based on another attribute of the computer environment, such as service.

FIG. 13 illustrates classification of the computer environments for each OS. In this case, there are two types of OSes (o1 and o2) that are applied to the computer environment. Each of the pieces of the attack result information 100 is classified into one of the two OS types, and the environment conditions are detected for each OS type. Then, the generation unit 2060 performs classification of the environment conditions for each of the groups of OSes o1 and o2.

Note that, as mentioned above, the selection rule 200 may show the exclusion condition instead of the inclusion condition. For example, the selection rule 200 may show the exclusion condition of “the environment condition is classified into the group G1, G3, or G4”, instead of the inclusion condition of “the environment condition is classified into the group G2”. In this case, the generation unit 2060 determines not to include the environment condition in the knowledge information 300 if the exclusion condition is satisfied, whereas the generation unit 2060 determines to include the environment condition in the knowledge information 300 if the exclusion condition is not satisfied.

The selection rule 200 is not limited to being defined by the groups mentioned above. For example, the selection rule 200 may be realized as a discriminator that is trained to determine whether to include the environment condition in the knowledge information 300 based on the feature of the attacks affected by the environment condition. In this case, training data may be a set of: the feature of the attacks affected by the environment condition; and a flag representing whether the environment condition is to be included in the knowledge information 300. The discriminator is trained with plural sets of the above-mentioned training data in advance.

When generating the knowledge information, the generation unit 2060 inputs the feature of the attacks affected by the environment condition into the discriminator, thereby obtaining the flag that represents whether that environment condition is to be included in the knowledge information 300. If the flag represents that the environment condition is to be included in the knowledge information 300, the generation unit 2060 includes that environment condition in the knowledge information 300. If the flag represents that the environment condition is not to be included in the knowledge information 300, the generation unit 2060 does not include that environment condition in the knowledge information 300.

### Generation of Knowledge Information: S108

The generation unit 2060 generates the knowledge information 300 that includes the environment conditions selected (determined to be included in the knowledge information 300) in Step 106 (S108). The structure of the knowledge information 300 is not limited to a specific one. FIGS. 14 and 15 illustrate example structures of the knowledge information 300. In the case of FIG. 14, the generation unit 2060 generates a single piece of the knowledge information 300 that shows a list of the selected environment conditions.

On the other hand, in the case of FIG. 15, the generation unit 2060 divides the selected environment conditions into multiple groups, and generates the knowledge information 300 for each group. For example, the environment conditions included in the same knowledge information 300 share a problem caused by the attacks that require the selected environment condition for their success. In other words, the knowledge information 300 is generated for each problem caused by the attacks.

As depicted in FIG. 15, it is preferable to include not only the environment condition but also the problem caused by the attacks in the knowledge information 300. The problem caused by each attack may be described in the result of the attack in the attack result information 100 corresponding to the attack.

The generation unit 2060 may use the description in the attack result information 100 as it is or may somehow modify the description. In the latter case, for example, the generation unit 2060 may generalize the description in the attack result information 100. Suppose that the result of attack in the attack result information 100 describes “an unknown program pr1 is executed with the root privilege”. This result implies that any program can be executed on the computer environment. Thus, the problem caused by this attack can be generalized as “any program can be executed”. In addition, suppose that the result of attack in the attack result information 100 describes “a file f1 is created”. Based on this attack result information 100, the problem of this attack can be generalized as “any file can be operated”.

The above-mentioned generalization may be realized using a pre-defined rule for converting a description in the result of attack in the attack result information 100 into more generalized description (conversion rule, hereinafter). The conversion rule may be stored, in advance, in a storage device to which the generation unit 2060 has access. FIG. 16 illustrates an example structure of the conversion rule. In FIG. 16, the conversion rule 400 is structured in a table format. The conversion rule 400 includes columns of a raw description 420 and a generalized problem 440. The raw description 420 represents a description in the result of attack in the attack result information 100. The generalized problem 440 represents the problem caused by the attacks in a generalized manner.

For each of the attacks affected by the environment condition selected in Step S106, the generation unit 2060 converts the result of attack in the attack result information 100 of the attack into the generalized problem in accordance with the conversion rule 400. Then, the generation unit 2060 classifies the attacks affected by the selected environment condition into groups based on the generalized problem. Specifically, the attacks whose respective generalized problems are the same as each other are classified into the same group. Then, the generation unit 2060 generates the knowledge information 300 for each group. The knowledge information 300 generated for a certain group includes the environment conditions that affects at least one of the attacks classified into that group and the generalized problem that those attacks have in common.

The generation unit 2060 outputs the generated knowledge information 300 in an arbitrary way. For example, the generation unit 2060 puts the knowledge information 300 into a storage device. In another example, the generation unit 2060 sends the knowledge information 300 to another computer, such as a computer used by a user of the knowledge generation apparatus 2000.

### Second Example Embodiment

The knowledge generation apparatus 2000 of the 2nd example embodiment provides the knowledge information 300 that indicates the problem caused by the attacks in a generalized manner together with the environment conditions that are necessary for the success of the attacks. A concrete way of performing this generalization is as described in the 1st example embodiment. The knowledge generation apparatus 2000 of the 2nd example embodiment does not necessarily narrow down the environment conditions to be included in the knowledge information 300 based on the feature of the set of the attacks.

For example, the knowledge generation apparatus 2000 of the 2nd example embodiment operates as follows. The knowledge generation apparatus 2000 obtains the plural pieces of the attack result information 100. The knowledge generation apparatus 2000 detects environment conditions that affect the attacks by comparing the plural pieces of the attack result information 100 with each other. For each of the attacks affected by at least one of the environment conditions, the knowledge generation apparatus 2000 converts the result of attack in the attack result information 100 into a generalized problem in accordance with the conversion rule 400. For each generalized problem, the knowledge generation apparatus generates the knowledge information 300 that includes that generalized problem and the environment conditions corresponding to that generalized problem.

Note that, “an environment condition corresponds to a certain generalized problem” means that a problem caused by the attack affected by the environment condition is generalized as the generalized problem.

### Example of Advantageous Effect

From the viewpoint of risk assessment, it may be preferable to be able to recognize what problem is caused by attacks in a generalized manner. According to the knowledge generation apparatus of the 2nd example embodiment, it is possible to obtain the knowledge information that indicates the problem caused by the attacks in a generalized manner. Thus, the knowledge generation apparatus of the 2nd example embodiment is capable of providing useful knowledge for risk assessment.

### Example of Functional Configuration

FIG. 17 is a diagram illustrating an example of a functional configuration of the knowledge generation apparatus 2000 of the 2nd example embodiment. The knowledge generation apparatus 2000 of the 2nd example embodiment includes the obtaining unit 2020, the detection unit 2040, and a 2nd generation unit 2080. The obtaining unit 2020 obtains the plural pieces of the attack result information 100. The detection unit 2040 detects the environment conditions that affect the attacks by comparing the plural pieces of the attack result information 100 with each other. The 2nd generation unit 2080 generates the knowledge information 300 that includes the generalized problem and the environment conditions corresponding to the generalized problem.

### Example of Hardware Configuration

The hardware configuration of the knowledge generation apparatus 2000 of the 2nd example embodiment may be illustrated by FIG. 3, similarly to that of the knowledge generation apparatus 2000 of the 1st example embodiment. However, the storage device 1080 of the 2nd example embodiment stores the program that implements the functions of the knowledge generation apparatus 2000 of the 2nd example embodiment.

### Flow of Process

FIG. 18 is a flow chart illustrating a flow of processes that the knowledge generation apparatus 2000 of the 2nd example embodiment performs. The obtaining unit 2020 obtains the plural pieces of the attack result information 100 (S202). The detection unit 2040 detects the environment conditions that affect the attacks by comparing the plural pieces of the attack result information 100 with each other (S204). For each of the attacks affected by at least one of the environment conditions, the 2nd generation unit 2080 converts the result of attack in the attack result information 100 into a generalized problem in accordance with the conversion rule 400 (S206). For each generalized problem, the 2nd generation unit 2080 generates the knowledge information 300 that includes that generalized problem and the environment conditions corresponding to that generalized problem (S208).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments and can be modified as appropriate without departing from the scope and spirit of the disclosure.

### Supplementary Notes

### Supplementary Note 1

A knowledge generation apparatus comprising:
at least one processor; and
a memory storing instructions,
wherein the at least one processor is configured to execute the instructions to:
   obtain plural pieces of attack result information each of which includes a configuration of an attack performed on a computer environment, a configuration of the computer environment, and a result of the attack;
   detect, through a comparison among the plural pieces of the attack result information, one or more environment conditions each of which is a condition regarding the configuration of the computer environment that is necessary for success of the attack; and
   generate knowledge information that includes some of the detected environment conditions, the some of the detected environment being selected based on a selection rule, the selection rule being a rule for determining whether to select the environment condition based on a feature of a set of attacks affected by the environment condition.

### Supplementary Note 2

The knowledge generation apparatus according to supplementary note 1, wherein the selection rule includes a rule for determining not to include the environment condition in the knowledge information if the environment condition is necessary for a normal operation of the computer environment.

### Supplementary Note 3

The knowledge generation apparatus according to supplementary note 1,
wherein the configuration of the attack includes an exploit code and a payload that form the attack, and
the feature of the set of the attacks affected by the environment condition is represented by the number of the exploit codes affected by the environment condition and
the number of the payloads affected by the environment condition.

### Supplementary Note 4

The knowledge generation apparatus according to supplementary note 3,
wherein the selection rule indicates one or more of groups of the environment condition, the environment conditions being classified into the groups based on the feature of the set of the attacks affected by the environment condition, the groups indicated by the selection rule including the environment condition to be selected, and
the generation of the knowledge information includes:
   classifying the detected environment conditions into the groups;
   selecting the detected environment condition included in any one of the groups indicated by the selection rule; and
   generating the knowledge information that includes the selected environment condition.

### Supplementary Note 5

The knowledge generation apparatus according to supplementary note 3,
wherein the selection rule indicates one or more of groups of the environment conditions, the environment conditions being divided into the groups based on the feature of the set of the attacks affected by the environment condition, the groups indicated by the selection rule including the environment condition not to be selected, and
the generation of the knowledge information includes:
   classifying the detected environment conditions into the groups;
   selecting the detected environment condition that is not included in any of the groups indicated by the selection rule; and
   generating the knowledge information that includes the selected environment condition.

### Supplementary Note 6

The knowledge generation apparatus according to supplementary note 3,
wherein the selection rule indicates a threshold of the number of the exploit codes affected by the environment condition, and
the generation of the knowledge information includes:
   selecting the detected environment condition if the number of the exploit codes affected by the environment condition is equal to or greater than the threshold; and
   generating the knowledge information that includes the selected environment condition.

### Supplementary Note 7

The knowledge generation apparatus according to supplementary note 3,
wherein the selection rule indicates a first threshold of the number of the exploit codes affected by the environment condition and a second threshold of the number of the payloads affected by the environment condition, and
the generation of the knowledge information includes:
   selecting the detected environment condition if the number of the exploit codes affected by the environment condition is equal to or greater than the first threshold and the number of the payloads affected by the environment condition is equal to or greater than the second threshold; and
   generating the knowledge information that includes the selected environment condition.

### Supplementary Note 8

The knowledge generation apparatus according to any one of supplementary notes 1 to 7,

wherein the generation of the knowledge information includes:
converting the result of the attack affected by the selected environment condition into a generalized problem, based on a predefined association between the result of the attack and the generalized problem, and
for each generalized problem, generating the knowledge information that includes the generalized problem and the selected environment condition that affects the attack whose result is converted into that generalized problem.

### Supplementary Note 9

A knowledge generation apparatus comprising:
at least one processor; and
a memory storing instructions,
wherein the at least one processor is configured to execute the instructions to:
   obtain plural pieces of attack result information each of which includes a configuration of an attack performed on a computer environment, a configuration of the computer environment, and a result of the attack;
   detect, through a comparison among the plural pieces of the attack result information, one or more environment conditions each of which is a condition regarding the configuration of the computer environment that is necessary for success of the attack;
   converting the result of the attack affected by the detected environment condition into a generalized problem, based on a predefined association between the result of the attack and the generalized problem;
   for each generalized problem, generating knowledge information that includes the generalized problem and the selected environment condition that affects the attack whose result is converted into that generalized problem.

### Supplementary Note 10

A control method performed by a computer, comprising:
obtaining plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack; and
generating knowledge information that includes some of the detected environment conditions, the some of the detected environment being selected based on a selection rule, the selection rule being a rule for determining whether to select the environment condition based on a feature of a set of attacks affected by the environment condition.

### Supplementary Note 11

The control method according to supplementary note 10,

wherein the selection rule includes a rule for determining not to include the environment condition in the knowledge information if the environment condition is necessary for a normal operation of the computer environment.

### Supplementary Note 12

The control method according to supplementary note 10,
wherein the configuration of the attack includes an exploit code and a payload that form the attack, and
the feature of the set of the attacks affected by the environment condition is represented by the number of the exploit codes affected by the environment condition and the number of the payloads affected by the environment condition.

### Supplementary Note 13

The control method according to supplementary note 12,
wherein the selection rule indicates one or more of groups of the environment conditions, the environment conditions being classified into the groups based on the feature of the set of the attacks affected by the environment condition, the groups indicated by the selection rule including the environment condition to be selected,
the generation of the knowledge information includes:
   classifying the detected environment conditions into the groups;
   selecting the detected environment condition included in any one of the groups indicated by the selection rule; and
   generating the knowledge information that includes the selected environment condition.

### Supplementary Note 14

The control method according to supplementary note 12,
wherein the selection rule indicates one or more of groups of the environment condition, the environment conditions being divided into the groups based on the feature of the set of the attacks affected by the environment condition, the groups indicated by the selection rule including the environment condition not to be selected, and
the selection of one or more environment conditions includes:
   classifying the detected environment conditions into the groups;
   selecting the detected environment condition that is not included in any of the groups indicated by the selection rule; and
   generating the knowledge information that includes the selected environment condition.

### Supplementary Note 15

The control method according to supplementary note 12,
wherein the selection rule indicates a threshold of the number of the exploit codes affected by the environment condition, and
the generation of the knowledge information includes:
   selecting the detected environment condition if the number of the exploit codes affected by the environment condition is equal to or greater than the threshold; and
   generating the knowledge information that includes the selected environment condition.

### Supplementary Note 16

The control method according to supplementary note 12,
wherein the selection rule indicates a first threshold of the number of the exploit codes affected by the environment condition and a second threshold of the number of the payloads affected by the environment condition, and
the generation of the knowledge information includes:
   selecting the detected environment condition if the number of the exploit codes affected by the environment condition is equal to or greater than the first threshold and the number of the payloads affected by the environment condition is equal to or greater than the second threshold; and
   generating the knowledge information that includes the selected environment condition.

### Supplementary Note 17

The control method according to any one of supplementary notes 10 to 16,

wherein the generation of the knowledge information includes:
converting the result of the attack affected by the selected environment condition into a generalized problem, based on a predefined association between the result of the attack and the generalized problem;
for each generalized problem, generating the knowledge information that includes the generalized problem and the selected environment condition that affects the attack whose result is converted into that generalized problem.

### Supplementary Note 18

A control method performed by a computer, comprising:
obtaining plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack;
converting the result of the attack affected by the detected environment condition into a generalized problem, based on a predefined association between the result of the attack and the generalized problem; and
for each generalized problem, generating knowledge information that includes the generalized problem and the selected environment condition that affects the attack whose result is converted into the generalized problem.

### Supplementary Note 19

A non-transitory computer readable storage medium storing a program that causes a computer to perform:
obtaining plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack;
generating knowledge information that includes some of the detected environment conditions, the part of the detected environment being selected based on a selection rule, the selection rule being a rule for determining whether to select the environment condition based on a feature of a set of attacks affected by the environment condition.

### Supplementary Note 20

The storage medium according to supplementary note 19,

wherein the selection rule includes a rule for determining not to include the environment condition in the knowledge information if the environment condition is necessary for a normal operation of the computer environment.

### Supplementary Note 21

The storage medium according to supplementary note 19,
wherein the configuration of the attack includes an exploit code and a payload that form the attack, and
the feature of the set of the attacks affected by the environment condition is represented by the number of the exploit codes affected by the environment condition and the number of the payloads affected by the environment condition.

### Supplementary Note 22

The storage medium according to supplementary note 21,
wherein the selection rule indicates one or more of groups of the environment conditions, the environment conditions being classified into the groups based on the feature of the set of the attacks affected by the environment condition, the groups indicated by the selection rule including the environment condition to be selected, and
the generation of the knowledge information includes:
   classifying the detected environment conditions into the groups;
   selecting the detected environment condition included in any one of the groups indicated by the selection rule; and
   generating the knowledge information that includes the selected environment condition.

### Supplementary Note 23

The storage medium according to supplementary note 21,
wherein the selection rule indicates one or more of groups of the environment condition, the environment conditions being divided into the groups based on the feature of the set of the attacks affected by the environment condition, the groups indicated by the selection rule including the environment condition not to be selected, and
the generation of the knowledge information includes:
   classifying the detected environment condition into the groups;
   selecting the detected environment condition that is not included in any of the groups indicated by the selection rule; and
   generating the knowledge information that includes the selected environment condition.

### Supplementary Note 24

The storage medium according to supplementary note 21,
wherein the selection rule indicates a threshold of the number of the exploit codes affected by the environment condition, and
the generation of the knowledge information includes:
   selecting the detected environment condition if the number of the exploit codes affected by the environment condition is equal to or greater than the threshold; and
   generating the knowledge information that includes the selected environment condition.

### Supplementary Note 25

The storage medium according to supplementary note 21,
wherein the selection rule indicates a first threshold of the number of the exploit codes affected by the environment condition and a second threshold of the number of the payloads affected by the environment condition, and
the generation of the knowledge information includes:
   selecting the detected environment condition if the number of the exploit codes affected by the environment condition is equal to or greater than the first threshold and the number of the payloads affected by the environment condition is equal to or greater than the second threshold; and
   generating the knowledge information that includes the selected environment condition.

### Supplementary Note 26

The storage medium according to any one of supplementary notes 19 to 25,

wherein the generation of the knowledge information includes:
converting the result of the attack affected by the selected environment condition into a generalized problem, based on a predefined association between the result of the attack and the generalized problem;
for each generalized problem, generating the knowledge information that includes the generalized problem and the selected environment condition that affects the attack whose result is converted into that generalized problem.

### Supplementary Note 27

A non-transitory computer readable storage medium storing a program that causes a computer to perform:
obtaining plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack;
converting the result of the attack affected by the detected environment condition into a generalized problem, based on a predefined association between the result of the attack and the generalized problem; and
for each generalized problem, generating knowledge information that includes the generalized problem and the selected environment condition that affects the attack whose result is converted into the generalized problem.

The whole or part of the example embodiments disclosed above can be described as, but not limited to, the following supplementary notes.

REFERENCE SIGNS LIST

| | |
|---|---|
| 100 | attack result information |
| 110 | attack identifier |
| 120 | attack configuration |
| 121 | exploit code |
| 122 | payload |
| 130 | environment configuration |
| 131 | OS |
| 132 | package list |
| 133 | service list |
| 134 | port list |
| 140 | result |
| 200 | selection rule |
| 300 | knowledge information |
| 400 | conversion rule |
| 420 | raw description |
| 440 | generalized problem |
| 1000 | computer |
| 1020 | bus |
| 1040 | processor |
| 1060 | memory |
| 1080 | storage device |
| 1100 | input/output interface |
| 1120 | network interface |
| 2000 | knowledge generation apparatus |
| 2020 | obtaining unit |
| 2040 | detection unit |
| 2060 | generation unit |
| 2080 | 2nd generation unit |

1. A knowledge generation apparatus comprising:
at least one processor; and
a memory storing instructions,
wherein the at least one processor is configured to execute the instructions to:
obtain plural pieces of attack result information each of which includes a configuration of an attack performed on a computer environment, a configuration of the computer environment, and a result of the attack;
detect, through a comparison among the plural pieces of the attack result information, one or more environment conditions each of which is a condition regarding the configuration of the computer environment that is necessary for success of the attack; and
generate knowledge information that includes some of the detected environment conditions, the some of the detected environment being selected based on a selection rule, the selection rule being a rule for determining whether to select the environment condition based on a feature of a set of attacks affected by the environment condition.

2. The knowledge generation apparatus according to claim 1,
wherein the selection rule includes a rule for determining not to include the environment condition in the knowledge information if the environment condition is necessary for a normal operation of the computer environment.

3. The knowledge generation apparatus according to claim 1,
wherein the configuration of the attack includes an exploit code and a payload that form the attack, and
the feature of the set of the attacks affected by the environment condition is represented by the number of the exploit codes affected by the environment condition and the number of the payloads affected by the environment condition.

4. The knowledge generation apparatus according to claim 3,
wherein the selection rule indicates one or more of groups of the environment conditions, the environment conditions being classified into the groups based on the feature of the set of the attacks affected by the environment condition, the groups indicated by the selection rule including the environment condition to be selected, and
the generation of the knowledge information includes:
classifying the detected environment conditions into the groups;
selecting the detected environment condition included in any one of the groups indicated by the selection rule; and
generating the knowledge information that includes the selected environment condition.

5. The knowledge generation apparatus according to claim 3,
wherein the selection rule indicates one or more of groups of the environment conditions, the environment conditions being divided into the groups based on the feature of the set of the attacks affected by the environment condition, the groups indicated by the selection rule including the environment condition not to be selected, and
the generation of the knowledge information includes:
classifying the detected environment conditions into the groups;
selecting the detected environment condition that is not included in any of the groups indicated by the selection rule; and
generating the knowledge information that includes the selected environment condition.

6. The knowledge generation apparatus according to claim 3,
wherein the selection rule indicates a threshold of the number of the exploit codes affected by the environment condition, and
the generation of the knowledge information includes:
selecting the detected environment condition if the number of the exploit codes affected by the environment condition is equal to or greater than the threshold; and
generating the knowledge information that includes the selected environment condition.

7. The knowledge generation apparatus according to claim 3,
wherein the selection rule indicates a first threshold of the number of the exploit codes affected by the environment condition and a second threshold of the number of the payloads affected by the environment condition, and
the generation of the knowledge information includes:
selecting the detected environment condition if the number of the exploit codes affected by the environment condition is equal to or greater than the first threshold and the number of the payloads affected by the environment condition is equal to or greater than the second threshold; and
generating the knowledge information that includes the selected environment condition.

8. The knowledge generation apparatus according to claim 1,
wherein the generation of the knowledge information includes:
converting the result of the attack affected by the selected environment condition into a generalized problem, based on a predefined association between the result of the attack and the generalized problem, and
for each generalized problem, generating the knowledge information that includes the generalized problem and the selected environment condition that affects the attack whose result is converted into that generalized problem.

9. A knowledge generation apparatus comprising:
at least one processor; and
a memory storing instructions,
wherein the at least one processor is configured to execute the instructions to:
obtain plural pieces of attack result information each of which includes a configuration of an attack performed on a computer environment, a configuration of the computer environment, and a result of the attack;
detect, through a comparison among the plural pieces of the attack result information, one or more environment conditions each of which is a condition regarding the configuration of the computer environment that is necessary for success of the attack;
converting the result of the attack affected by the detected environment condition into a generalized problem, based on a predefined association between the result of the attack and the generalized problem;
for each generalized problem, generating knowledge information that includes the generalized problem and the selected environment condition that affects the attack whose result is converted into that generalized problem.

10. A control method performed by a computer, comprising:
obtaining a plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack; and
generating knowledge information that includes some of the detected environment conditions, the part of the detected environment being selected based on a selection rule, the selection rule being a rule for determining whether to select the environment condition based on a feature of a set of attacks affected by the environment condition.

11. The control method according to claim 10,
wherein the selection rule includes a rule for determining not to include the environment condition in the knowledge information if the environment condition is necessary for a normal operation of the computer environment.

12. The control method according to claim 10,
wherein the configuration of the attack includes an exploit code and a payload that form the attack, and
the feature of the set of the attacks affected by the environment condition is represented by the number of the exploit codes affected by the environment condition and the number of the payloads affected by the environment condition.

13. The control method according to claim 12,
wherein the selection rule indicates one or more of groups of the environment condition, the environment conditions being classified into the groups based on the feature of the set of the attacks affected by the environment condition, the groups indicated by the selection rule including the environment condition to be selected,
the generation of the knowledge information includes:
classifying the detected environment conditions into the groups;
selecting the detected environment condition included in any one of the groups indicated by the selection rule; and
generating the knowledge information that includes the selected environment condition.

14. The control method according to claim 12,
wherein the selection rule indicates one or more of groups of the environment condition, the environment conditions being divided into the groups based on the feature of the set of the attacks affected by the environment condition, the groups indicated by the selection rule including the environment condition not to be selected, and
the selection of one or more environment conditions includes:
classifying the detected environment condition into the groups;
selecting the detected environment condition that is included neither of the groups indicated by the selection rule; and
generating the knowledge information that includes the selected environment condition.

15. The control method according to claim 12,
wherein the selection rule indicates a threshold of the number of the exploit codes affected by the environment condition, and
the generation of the knowledge information includes:
selecting the detected environment condition if the number of the exploit codes affected by the environment condition is equal to or greater than the threshold; and
generating the knowledge information that includes the selected environment condition.

16. The control method according to claim 12,
wherein the selection rule indicates a first threshold of the number of the exploit codes affected by the environment condition and a second threshold of the number of the payloads affected by the environment condition, and
the generation of the knowledge information includes:
selecting the detected environment condition if the number of the exploit codes affected by the environment condition is equal to or greater than the first threshold and the number of the payloads affected by the environment condition is equal to or greater than the second threshold; and
generating the knowledge information that includes the selected environment condition.

17. The control method according to claim 10,
wherein the generation of the knowledge information includes:
converting the result of the attack affected by the selected environment condition into a generalized problem, based on a predefined association between the result of the attack and the generalized problem;
for each generalized problem, generating the knowledge information that includes the generalized problem and the selected environment condition that affects the attack whose result is converted into that generalized problem.

18. (canceled)

19. A non-transitory computer readable storage medium storing a program that causes a computer to perform:
obtaining a plural pieces of attack result information each of which includes a configuration of an attack performed on a computer environment, a configuration of the computer environment, and a result of the attack;
detecting, through a comparison among the plural pieces of the attack result information, one or more environment conditions each of which is a condition regarding the configuration of the computer environment that is necessary for success of the attack;
generating knowledge information that includes some of the detected environment conditions, the part of the detected environment being selected based on a selection rule, the selection rule being a rule for determining whether to select the environment condition based on a feature of a set of attacks affected by the environment condition.

20. The storage medium according to claim 19,
wherein the selection rule includes a rule for determining not to include the environment condition in the knowledge information if the environment condition is necessary for a normal operation of the computer environment.

21. The storage medium according to claim 19,
wherein the configuration of the attack includes an exploit code and a payload that form the attack, and
the feature of the set of the attacks affected by the environment condition is represented by the number of the exploit codes affected by the environment condition and the number of the payloads affected by the environment condition.

22. The storage medium according to claim 21,
wherein the selection rule indicates one or more of groups of the environment condition, the environment conditions being classified into the groups based on the feature of the set of the attacks affected by the environment condition, the groups indicated by the selection rule including the environment condition to be selected, and
the generation of the knowledge information includes:
classifying the detected environment conditions into the groups;
selecting the detected environment condition included in any one of the groups indicated by the selection rule; and
generating the knowledge information that includes the selected environment condition.

23. The storage medium according to claim 21,
wherein the selection rule indicates one or more of groups of the environment condition, the environment conditions being divided into the groups based on the feature of the set of the attacks affected by the environment condition, the groups indicated by the selection rule including the environment condition not to be selected, and
the generation of the knowledge information includes:
classifying the detected environment condition into the groups;
selecting the detected environment condition that is included neither of the groups indicated by the selection rule; and
generating the knowledge information that includes the selected environment condition.

24. The storage medium according to claim 21,
wherein the selection rule indicates a threshold of the number of the exploit codes affected by the environment condition, and
the generation of the knowledge information includes:
selecting the detected environment condition if the number of the exploit codes affected by the environment condition is equal to or greater than the threshold; and
generating the knowledge information that includes the selected environment condition.

25. The storage medium according to claim 21,
wherein the selection rule indicates a first threshold of the number of the exploit codes affected by the environment condition and a second threshold of the number of the payloads affected by the environment condition, and
the generation of the knowledge information includes:
selecting the detected environment condition if the number of the exploit codes affected by the environment condition is equal to or greater than the first threshold and the number of the payloads affected by the environment condition is equal to or greater than the second threshold; and
generating the knowledge information that includes the selected environment condition.

26. The storage medium according to claim 19,
wherein the generation of the knowledge information includes:
converting the result of the attack affected by the selected environment condition into a generalized problem, based on a predefined association between the result of the attack and the generalized problem;
for each generalized problem, generating the knowledge information that includes the generalized problem and the selected environment condition that affects the attack whose result is converted into that generalized problem.

27. (canceled)
